(19) United States
(12) Patent Application Publication
(10) Pub. No.: US 2026/0326675 A1
(43) Pub. Date: Oct. 22, 2026

(54) AN ITEM CARRYING BRACKET FOR USE IN RETAINING AN ITEM ON A MOTOR VEHICLE

(71) Applicant: Rhino Rack Australia Pty Limited, Eastern Creek (AU)

(72) Inventors: Oliver LYNCH, New South Wales (AU); Tarek ALFAKHRANY, New South Wales (AU)

(21) Appl. No.: 19/122,987

(22) PCT Filed: Sep. 14, 2023
(86) PCT No.: PCT/AU2023/050884

§ 371 Date: Apr. 21, 2025

(30) Foreign Application Priority Data
Oct. 19, 2022 (AU) 2022903073

(51) Int. Cl. B60R 9/048

(52) U.S. Cl. CPC B60R 9/048

(57) ABSTRACT

An item carrying bracket for use in retaining an item on a motor vehicle is disclosed including: first and second bracket members; the bracket members are joined at a hinge and can rotate with respect to one another between a closed condition and an open condition; in the open condition an item to be carried may be introduced between the bracket members; in the closed condition the bracket members surround and retain the item; and the bracket includes a dampening mechanism which dampens the movement of the bracket members from the closed condition to the open condition; and wherein the resistance of the damping mechanism progressively increases as the bracket moves towards the open condition.

### TECHNICAL FIELD

This disclosure relates in general to item carrying arrangements for vehicles.

### BACKGROUND TO THE DISCLOSURE

Sometimes it is desirable to transport an item on the outside of a motor vehicle. The item may be too bulky to fit inside the vehicle, or it may be desired to use available storage space within the vehicle for other purposes. An item carrying arrangement can be used which is affixed to the vehicle and is adapted to hold or restrain the item.

In order to carry an elongate item, such as a shovel or other tool, it has been tried to use item carrying devices in the form of brackets. The brackets have a fixed jaw which is affixed to a vehicle, or a roof rack of a vehicle and a moveable jaw is hingedly attached to the fixed jaw. The item is held in the bracket by closing the jaws around the item. Usually, a pair of brackets is used at spaced apart locations along the vehicle or roof rack.

It has been tried to dampen the movement of the moveable jaw of these brackets by providing some type of friction to the movement of the jaw. It has been tried to apply friction by positioning one or more deformable washers between the jaws at the hinge joint and tightening a hinge pin at the hinge joint to create some preload force in the deformable washers to generate a frictional force which must be overcome to open or close the brackets. However, it has been found that the washers may wear quite quickly, and the preload force is lost, making the movement of the brackets loose.

There remains a need for improved item carrying arrangements for vehicles.

### SUMMARY OF THE DISCLOSURE

In a first aspect the present disclosure provides an item carrying bracket for use in retaining an item on a motor vehicle including: first and second bracket members; the bracket members are joined at a hinge and can rotate with respect to one another between a closed condition and an open condition; in the open condition an item to be carried may be introduced between the bracket members; in the closed condition the bracket members surround and retain the item; and the bracket includes a dampening mechanism which dampens the movement of the bracket members from the closed condition to the open condition; and wherein the resistance of the damping mechanism progressively increases as the bracket moves towards the open condition.

The dampening mechanism may include planar surfaces provided on the first or second hinge members, the planes of the surfaces may be angled with respect to the hinge axis; when in the closed condition the planes of the surfaces may be substantially parallel to one another, and as the bracket moves from the closed condition towards the open condition the surfaces may cause interference to dampen the movement of the bracket members.

The at least one compressible washer may be located between the surfaces.

The hinge may include a hinge pin, and the hinge pin may be tightened or loosened to adjust the amount of dampening applied to the movement of the bracket members.

The bracket may include a latching mechanism to retain the bracket in the closed condition.

The bracket may include a locking mechanism to prevent unauthorised movement of the bracket towards the open condition.

In a second aspect the present disclosure provides a bracket for use in retaining an item on a motor vehicle including: first and second bracket members; the bracket members are joined at a hinge and can rotate with respect to one another between a closed condition and an open condition; in the open condition an item may be introduced between the bracket members; and in the closed condition the bracket members surround and retain the item; and a removable insert is located inside the bracket members which engages with and supports the item being held in the bracket in use.

The insert may include an upstanding pin which in use engages with the shaft of a hi lift jack.

The insert may include a region of deformable resilient material which conforms to the item being held in use.

In a third aspect the present disclosure provides an item carrying arrangement on a vehicle including: two or more brackets according to any preceding claim, the brackets being mounted to the vehicle at spaced apart locations to support different regions of an item in use.

One of the bracket members of each bracket may be affixed to the vehicle and the other bracket member may open in a downward direction.

One of the bracket members of each bracket may be affixed to the vehicle and the other bracket member may open in an upwards direction.

### BRIEF DESCRIPTION OF THE DRAWINGS

Embodiments will now be described, by way of example only, with reference to the accompanying drawings, in which:

FIG. 1 is a side view of an item carrying bracket for use in retaining an item on a motor vehicle in a closed condition;

FIG. 2 shows the bracket of FIG. 1 in an open condition;

FIGS. 3 and 4 are rear perspective cut away views of the bracket of FIG. 1;

FIGS. 5A and 5B illustrate the compression of a resilient washer in the bracket of FIG. 1 as the bracket moves to the open condition;

FIGS. 6 to 8 show brackets according to FIG. 1 used in a side mount configuration with a vehicle;

FIGS. 9 and 10 show brackets used in a top mount configuration; and

FIG. 11 shows the bracket of FIG. 1 fitted with an alternative insert.

### DETAILED DESCRIPTION OF EMBODIMENTS

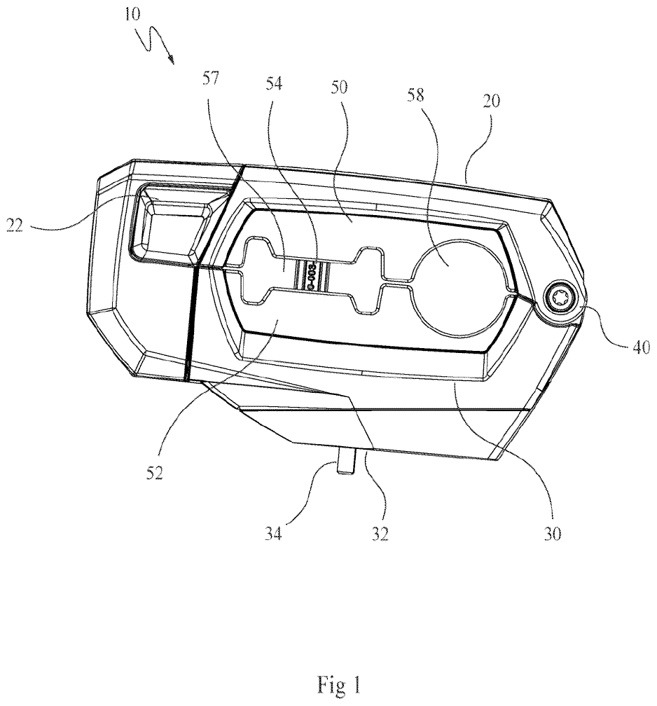

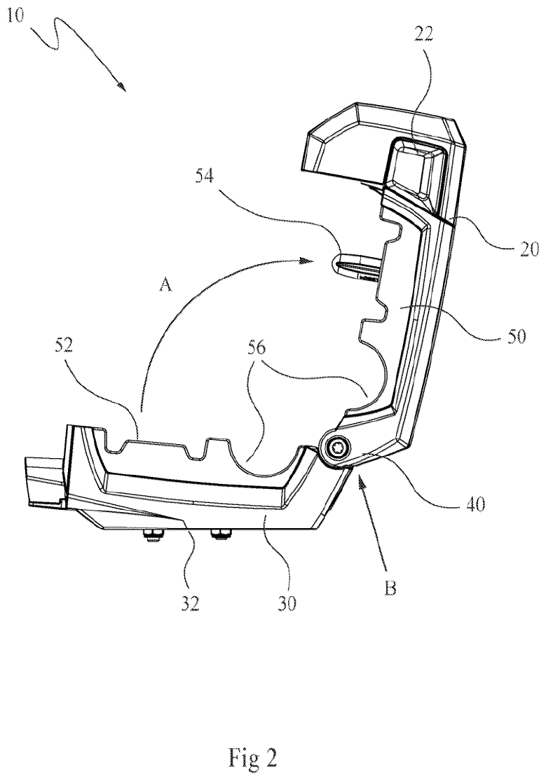

Referring to FIGS. 1 and 2, an item carrying bracket 10 is shown for use in retaining an item on a motor vehicle. Bracket 10 includes a first bracket member in the form of moveable jaw 20 which is rotatably joined to fixed jaw 30 by way of hinge 40.

The jaws 20 and 30 can rotate with respect to one another between a closed condition shown in FIG. 1 and an open condition shown in FIG. 2 as indicated by arrow A in FIG. 2. The moveable jaw 20 rotates by 100 degrees to reach the open condition which is defined by a hard stop provided by the abutment of the two jaws in the region indicated by arrow B. When in the open condition, an item to be retained be introduced between the jaws 20, 30 and when in the closed condition, the jaws 20, 30 surround and support the item.

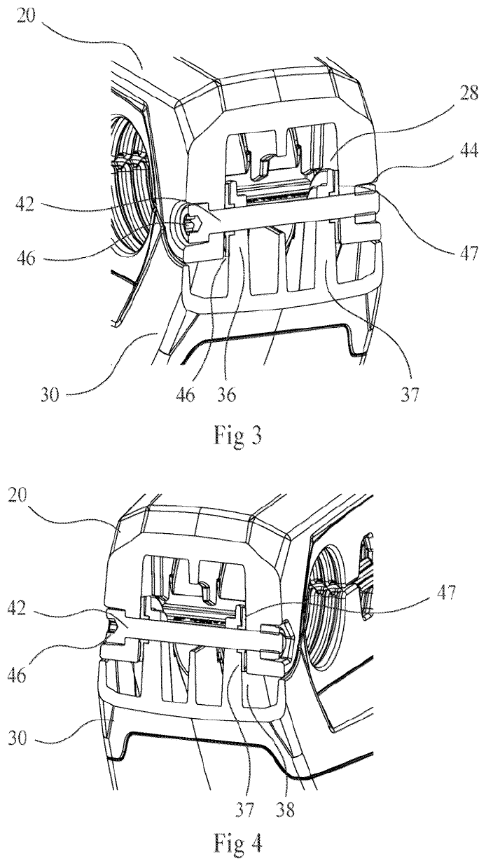

Referring to FIGS. 3 and 4 hinge 40 includes a hinge pin in the form of a hinge bolt 42 which passes through jaw 20 and also through apertures provided in two upstanding ribs 36, 37 which are located inside jaw 30. Hinge bolt 42 has a threaded end region which is received inside nut 44. Two circular compressible washers 46, 47 are retained on the hinge bolt 42 in regions between the ribs 36, 37 and jaw 20.

Bracket 10 includes a dampening mechanism which dampens the movement of the bracket members from the closed condition to the open condition which includes two opposed planar surfaces 28, 38 of the jaws face each other. The surfaces 28, 38 are planar in the region of the washer 47 and are angled with respect to the hinge axis. They are offset at an angle from a line orthogonal to the hinge axis by 2 degrees. The angular offset of the surfaces gives rise to compression of the washer 47 which creates the dampening effect of the dampening mechanism.

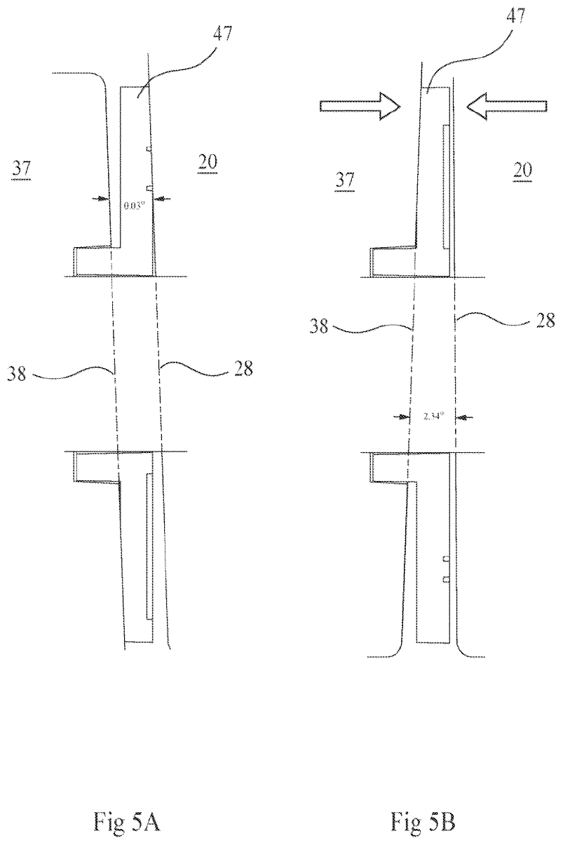

Referring now to FIGS. 5A and 5B, the offset angles of the surfaces are illustrated in exaggerated form to better explain the operation of the concept of the dampening mechanism. In FIG. 5A, the bracket is in the closed condition. The surfaces 28, 38 are parallel to one another. In FIG. 5B, the bracket is in the open condition. The relative rotation of the surfaces 28, 38 in means they are no longer parallel to one another. They are now offset by about 2 degrees. This causes compression of the resilient washer 47 in the region indicated by the solid arrows in the figure. The compression of the washer causes friction between the surfaces 28, 38 and the washer. This creates a drag which dampens the movement of the bracket.

It can be seen that, as the hinge moves from the closed condition to the open condition the effective relative offset of the angles of the faces 28, 38 progressively increases. This has two effects. Firstly, this progressively increases the dampening force as the hinge moves towards the open condition. Secondly, the onset of the dampening force can be controlled to occur at a particular degree of angular opening of the jaw.

The angle of onset of the dampening force, and the amount of dampening force, is controlled by a user by adjusting the effective width of the hinge bolt 42. This is achieved by inserting an Allen key into the formation 46 in the end of the hinge bolt and rotating the bolt 42 with respect to the nut 44. Tightening the hinge bolt pinches the hinge assembly together, reducing the width of the space occupied by the compressible washers. This causes the frictional dampening force to be greater at a smaller degree of opening of the jaws. Also, the frictional force at the position of maximum jaw opening is increased.

Referring again to FIG. 1, bracket includes a latching mechanism. A spring-loaded detent inside jaw 20 engages with a formation in jaw 30 when the bracket is put into the closed condition. The detent of the latching mechanism is released by depressing button 22.

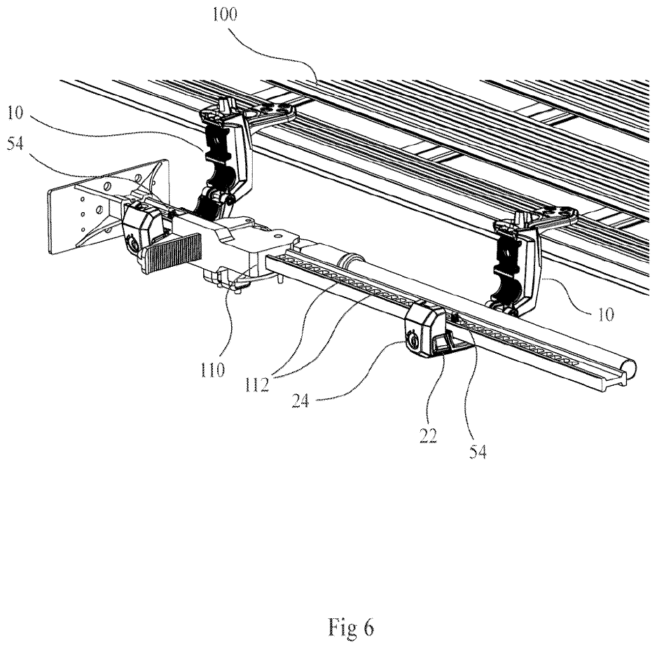

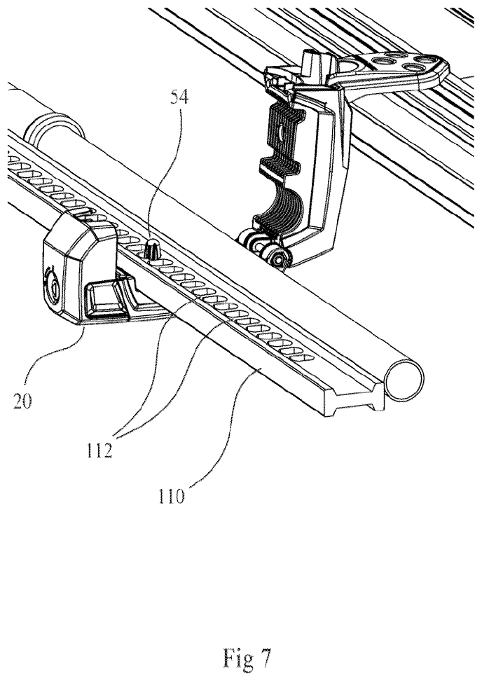

As best seen in FIG. 6, bracket 10 also includes a locking mechanism which includes a key operated lock barrel 24. The lock barrel can be put in into a locked condition to prevent the button 22 from being depressed to release the latching mechanism.

The jaws are formed from cast aluminium. The pin 54 and hinge pin 42 and nut 44 may be formed from steel.

Examples of item carrying arrangements incorporating brackets 10 will now be described with reference to stowing a hi lift jack on a vehicle. A hi lift jack is a piece of equipment used on offroad/overlanding/touring vehicles. Its purpose is a mechanical vehicle jack/lift. Being mechanical makes it a reliable component for agricultural use or offroad vehicle in remote areas. Its travel range compared to a traditional car jack/lift also is advantageous. The hi lift jack is a large item which is inconvenient to carry inside vehicles.

Referring again to FIGS. 1 and 2, bracket 10 is fitted with a removable insert which is provided in two halves 50, 52. The two halves are push fitted into their respective jaws 20, 30. The insert is configured to make bracket 10 suitable for stowing a hi lift jack. The insert halves are formed from an elastomeric material and are shaped so that when in the closed condition the insert halves form a dog bone shaped aperture 57 which conforms around the leg of the jack, and a circular aperture 58 which confirms around the handle of the jack. A pin 54 is provided in insert half 50 which engages with one of a series of holes provided on the leg of the jack.

Referring to FIGS. 6 and 7, two of brackets 10 are shown in a side mount configuration to retain a hi lift jack 110 in relation to a vehicle. The brackets 10 are attached to a roof rack 100 of the vehicle at spaced apart locations along the length of a side region of the roof rack 100.

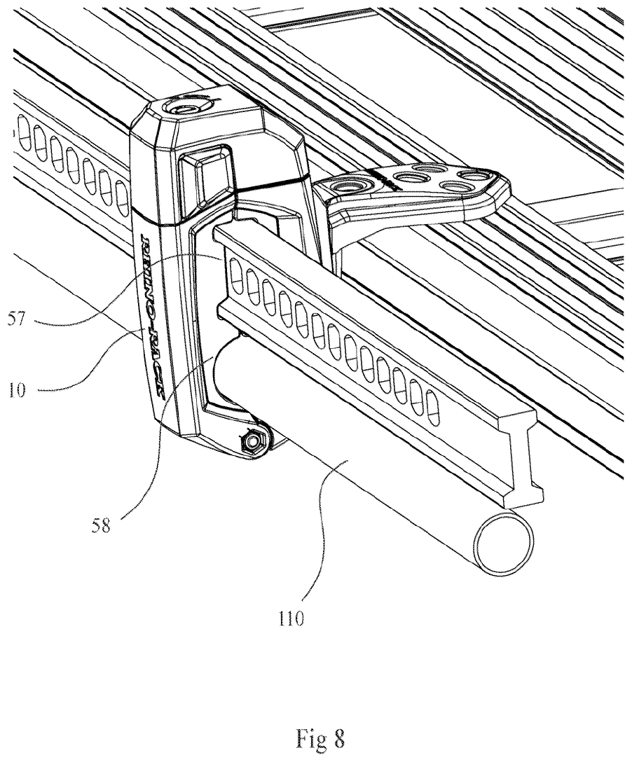

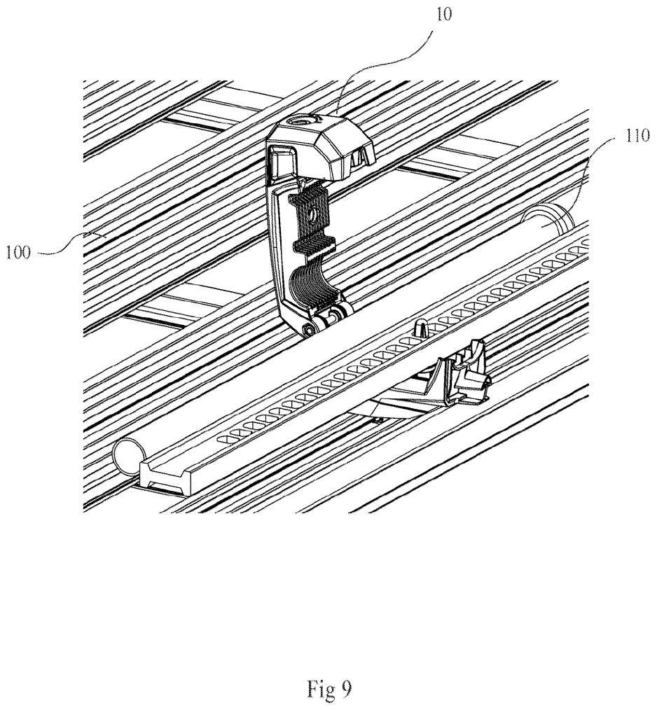

In order to stow the hi lift jack the brackets 10 are moved by the user into their open conditions. The hi lift jack is then rested on the two jaws 20 of the brackets so that the pins 54 of the inserts (pin 54 best seen in FIG. 7) each engage with one of a series of holes 112 provided along the length of the jack 110. The handle of the jack lies in the half circular recess 56 of insert half 50. The moveable jaws 20 are then lifted using one hand under each jaw 20 to rotate the jaws and jack 110 in unison to close the brackets 10 by engaging the latches of the brackets to arrive at the configuration shown in FIG. 8. The elastomeric material of the insert becomes slightly compressed in the regions of the apertures 57, 58 around the leg and handle of the jack to snugly clamp around the jack to retain the jack in place. The hi lift jack is now retained for carrying on the vehicle. The brackets 10 can optionally be locked to prevent unauthorised removal of the jack.

In order to release the jack, the latch buttons 22 of the brackets are depressed to release their respective latching mechanisms and the jaws 20 are pulled open in a downwards direction. The brackets 10 open against the damping action of the compressible washers. This slows the opening movement of the brackets which would otherwise open quite suddenly under the weight of jack 110 which can weigh of the order of 14-16 kg. Opening the brackets without dampening would otherwise present a hazard/danger to the user or vehicle when opened. In addition, when the bracket is near to the fully open position, the dampening action prevents jaw 20 from contacting the hard stops with high impact. With the brackets open, the jack 110 can be removed. The brackets 10 may then be returned to their closed conditions.

As explained above, the amount of friction force and the opening angle at which dampening is applied can be adjusted by adjusting the hinge pin. Therefore, the brackets can be adjusted to suit jacks which are lighter or heavier, or can be adjusted to be used with other accessories of different weights. The hinge pin can also be adjusted to increase the friction force to compensate for wear in the compressible washers over time.

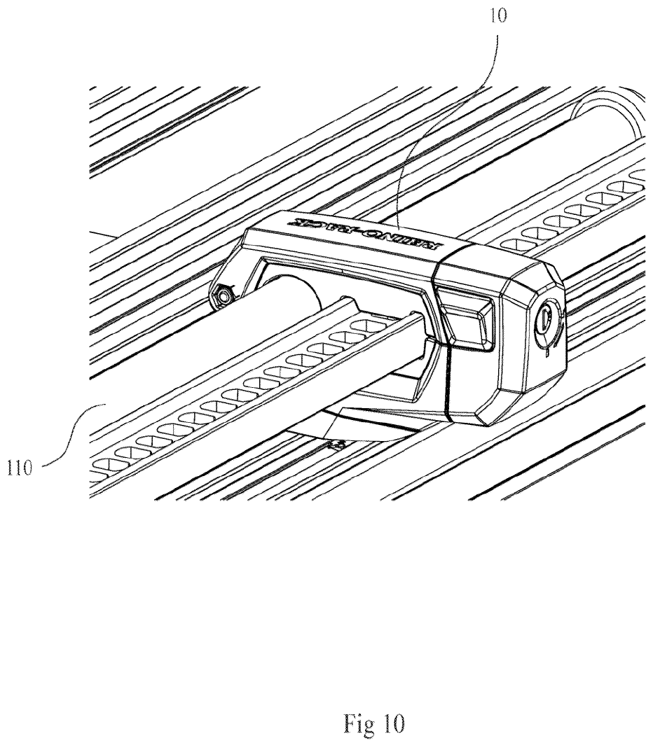

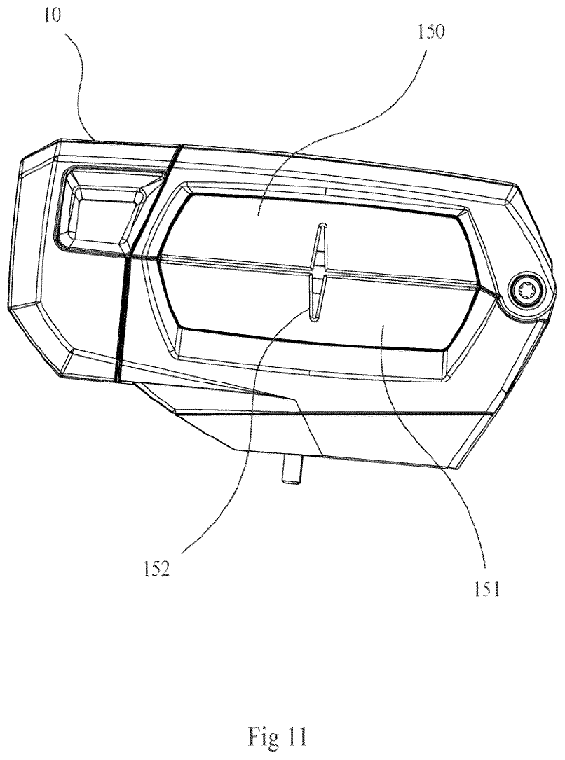

Referring now to FIGS. 10 and 11, use of the brackets in a top mount configuration is shown. This arrangement differs from the arrangement of FIGS. 6 to 8 in that the fixed lower jaw 30 is mounted in a horizontal, rather than a vertical, orientation. Also, the insert halves 50, 52 are swapped over within the jaws so that the pin 54 is located in the fixed jaw 30. In this configuration, in order to stow the jack, the brackets 10 are firstly put into their open configurations. The brackets are opened in an upwards direction by raising both of the moveable jaws in turn by hand against the dampening action of the brackets. The dampening action retains the moveable jaw 20 of the bracket in the open condition. This allows a user to have both hands free to lift the jack up and rest it on the two fixed jaws 30 to engage the jack with the pins 54. The moveable jaws 20 may then be closed by rotating them in a downwards direction to their latching positions. Removal of the jack 110 is achieved by reversing this procedure.

The dampening action therefore provides both a safety feature to prevent sudden opening of the bracket as well as improving ease of use in providing a smooth opening action and holding the brackets open when in a top mount configuration.

The bracket 10 may be reconfigured for use with other types of items by using a different insert in the bracket. Referring to FIG. 11, an alternative insert is shown in the bracket formed from halves 150 and 151. The insert is formed from resilient elastomeric material and is shaped to provide a diamond shaped aperture 152. This insert can be used for stowing differently shaped items such as shovels, rods or other items.

It can be seen that embodiments have at least one of the following advantages:
The dampening action provides a controlled opening operation of the bracket in a downward direction when the bracket is retaining a heavy item improving safety of operation.
The progressive dampening action can prevent the hinge hitting its fully open stops in a sudden manner, improving comfort of operation.
The dampening action allows the moveable jaws of the brackets to be held open when used in an upwardly opening direction. This allows both hands to be used to lift the item to be retained into the brackets.
The progressive increase in the dampening force generated by the angular offset surfaces is not immediately lost if the resilient washers wear over time. Instead, the angle of the onset of the friction force changes.
Replaceable inserts allow brackets to be used to retain a variety of differently shaped items.

While the disclosure has been described with reference to exemplary preferred embodiments above, it will be appreciated by those of ordinary skilled in the art that it is not limited to those embodiments, but may be embodied in many other forms, variations and modifications other than those specifically described. This disclosure includes all such variation and modifications. The disclosure also includes all of the steps, features, components and/or devices referred to or indicated in the specification, individually or collectively and any and all suitable combinations or any two or more of the steps or features.

In this specification, unless the context clearly indicates otherwise, the word “comprising” is not intended to have the exclusive meaning of the word such as “consisting only of”, but rather has the non-exclusive meaning, in the sense of “including at least”. The same applies, with corresponding grammatical changes, to other forms of the word such as “comprise”, etc.

Other definitions for selected terms used herein may be found within the detailed description and apply throughout. Unless otherwise defined, all other scientific and technical terms used herein have the same meaning as commonly understood to one of ordinary skill in the art to which the disclosure belongs.

Any promises made in the present document should be understood to relate to some embodiments of the disclosure and are not intended to be promises made about the invention in all embodiments. Where there are promises that are deemed to apply to all embodiments of the invention, the applicant/patentee reserves the right to later delete them from the description and they do not rely on these promises for the acceptance or subsequent grant of a patent in any country.

In the foregoing description of certain embodiments, specific terminology has been resorted to for the sake of clarity. However, the disclosure is not intended to be limited to the specific terms so selected, and it is to be understood that a specific term includes other technical equivalents which operate in a similar manner to accomplish a similar technical purpose. Terms such as “left” and right“, “front” and “rear”, “above” and “below” and the like are used as words of convenience to provide reference points and are not to be construed as limiting terms.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. An item carrying bracket for use in retaining an item on a motor vehicle including:
first and second bracket members;
the bracket members are joined at a hinge and can rotate with respect to one another between a closed condition and an open condition;
in the open condition an item to be carried may be introduced between the bracket members;
in the closed condition the bracket members surround and retain the item; and
the bracket includes a dampening mechanism which dampens the movement of the bracket members from the closed condition to the open condition; and
wherein the resistance of the damping mechanism progressively increases as the bracket moves towards the open condition.

2. A bracket according to claim 1 wherein the dampening mechanism includes planar surfaces provided on the first or second hinge members, the planes of the surfaces are angled with respect to the hinge axis; when in the closed condition the planes of the surfaces are substantially parallel to one another, and as the bracket moves from the closed condition towards the open condition the surfaces cause interference to dampen the movement of the bracket members.

3. A bracket according to claim 2 wherein at least one compressible washer is located between the surfaces.

4. A bracket according to any preceding claim wherein the hinge includes a hinge pin, and the hinge pin may be tightened or loosened to adjust the amount of dampening applied to the movement of the bracket members.

5. A bracket according to any preceding claim including a latching mechanism to retain the bracket in the closed condition.

6. A bracket according to any preceding claim including a locking mechanism to prevent unauthorised movement of the bracket towards the open condition.

7. A bracket for use in retaining an item on a motor vehicle including:
first and second bracket members;
the bracket members are joined at a hinge and can rotate with respect to one another between a closed condition and an open condition;
in the open condition an item may be introduced between the bracket members; and
in the closed condition the bracket members surround and retain the item; and
a removable insert is located inside the bracket members which engages with and supports the item being held in the bracket in use.

8. A bracket according to claim 7 wherein the insert includes an upstanding pin which in use engages with the shaft of a hi lift jack.

9. A bracket according to claim 7 wherein the insert includes a region of deformable resilient material which conforms to the item being held in use.

10. An item carrying arrangement on a vehicle including:
two or more brackets according to any preceding claim, the brackets being mounted to the vehicle at spaced apart locations to support different regions of an item in use.

11. An arrangement according to claim 10 wherein one of the bracket members of each bracket is affixed to the vehicle and the other bracket member opens in a downward direction.

12. An arrangement according to claim 10 wherein one of the bracket members of each bracket is affixed to the vehicle and the other bracket member opens in an upwards direction.
